(19) United States
(12) Patent Application Publication
(10) Pub. No.: US 2014/0082605 A1
(43) Pub. Date: Mar. 20, 2014

(54) Method for adjusting of binary files built under one initial operating system environment in a way to load on multiple other operating system environments which include customizing information, and software programs based on the method

(71) Applicant: Paul (Plamen) Arssov, Vancouver (CA)

(72) Inventor: Paul (Plamen) Arssov, Vancouver (CA)

(21) Appl. No.: 13/619,997

(22) Filed: Sep. 14, 2012

(51) Int. Cl. G06F 9/445

(52) U.S. Cl. 717/174

(57) ABSTRACT

A method for adjusting of a binary file built under one initial operating system environment in a way to load on multiple other target operating system (os) environments which include customizing information, where both the said file and the files of the target os-es are analyzed and data within the said file is replaced with data obtained from the binaries of the target os-es. One or more software programs implemented based on the method.

### BACKGROUND OF THE INVENTION

1. Field of invention

The invention herein relates to operating systems and programs loaded on them.

2. Description of Related Art

The invention applies to operating system environments which customize software at the point of installing it in such a way to be used only on the specific computer system on which the installing is done.

A specific example is the way of building of device drivers, also known as kernel modules or kernel drivers, under Linux operating system.

Operating systems (os) include programs running on ‘upper/user/application’ level and programs operating on ‘lower/system/kernel’ level.

Device drivers are programs which operate on lower level and for example do control of hardware, or provide system services. In their operations they call and use kernel functions like for ex. to—allocate kernel memory, get a virtual address, copy data between user and kernel space, etc. These functions and commonly called kernel symbols, or just symbols.

Starting with Linux kernel numbers 2.6, the device drivers are built in a way to include information for the symbols used by the specific driver and a unique number is generated for each individual symbol—commonly called CRC or checksum.

More information on the Linux kernel and device drivers can be found on this web site—‘kernel.org’, under ‘documentation’ page and other related pages. A kernel may be downloaded as a single zipped file. When unzipped, it may have—‘/Documentation/kbuild’ folder, which may contain ‘modules.txt’ file. This file includes information on symbols and checksums.

Linux releases are commonly called distributions/distros provided by a number of small or large organizations like for ex.—Ubuntu, Suse, RedHat . . . These organizations provide continuously newer operating system releases which include updated or new software and a newer kernel release.

The operating system can be installed on a wide variety of computer hardware—desktop systems, notebooks, embedded, industrial systems, etc.

When the Linux operating system is installed, the checksums for all symbols are generated and included in the kernel and the device drivers. This checksum value is the same for one symbol used by different drivers—within the installed operating system. However the checksum has a different value for one symbol on another computer system, and/or another kernel release, and/or another operating system distribution.

In this way a binary of a device driver from one Linux system can not be loaded and used on another Linux system.

Any difference in the computer hardware—for ex. different motherboard, and the driver binary is not going to load, even when the kernel and distro are the same.

Any difference in the Linux kernel—for ex. a patch or the next release, and the driver binary is not going to load, even when the hardware and distro are the same.

Any difference in the distribution—for ex. a patch or the next release, and the driver binary is not going to load, even when the computer and the kernel are the same.

Alternative solutions to the issue of loading and using of a binary of a device driver from one Linux system on another Linux system include:

1. either to include the driver to be distributed with the Linux kernel
2. or, do a rebuilding for thousands of times for each combination of—>
system hardware/kernel release/distribution

Taking the first choice will lead to revealing the source code of the driver, putting it to the scrutiny of the kernel developer's community, and eventually incorporating it in the kernel.

The initial developer—individual or a company, may get being listed in the ‘credits’ section of a specific source, however no longer will own or control the code.

In exchange for the benefit of being supported on any kernel, the code becomes a commodity which may be exploited by anyone—including competitors of the initial developer.

Taking the second choice means that a unique binary of the driver has to be build, and this binary can load and work only on the same or an identical computer system.

Within the 2 extremes of alternative solutions are multiple other solutions where the developer may provide a portion of the source code for the driver, or offer a ‘service layer’ with source code for the kernel functions.

Using of a ‘service layer’ may minimize the number of ‘symbols’ used by a driver however a Linux driver may still need several basic/essential ‘symbols’.

Then, once a driver is built and a binary produced it can only be loaded on the current os environment and not on another Linux os environment.

The currently available solutions to this issue place limitations to both—the code owner/developer/company, and customer/user:
the user can get the source code to build the driver however has to sign a NDA
or, the company will sell a complete system which includes the hardware
or, a single or a team of driver developers has to constantly deal with updating and patching customers

### SUMMARY OF THE INVENTION

The invention applies in cases where the operating system is designed in a way to use information to customize software programs for work only on environments identical to the current environment—like for example for device drivers under Linux os.

A Linux device driver if a binary file which include within them information which customizes them in a way to be able to load on the current system, and to prevent loading on a different system.

This customizing information for a Linux device driver among other things may include:
the names of the kernel symbols and their checksums
the Linux version string (‘vermagic’) which relate to kernel release number, and distribution

When having a binary of a Linux driver produced on one environment, the essence of the invention is to adjust the binary, identified as outside driver, in a way to load on multiple other operating systems.

The process of adjusting is as follows—
reading of the outside driver file, locating and extracting of the customizing information
reading of the files belonging to the current operating system locating and collecting of the customizing information
replacing of the customizing information in the outside driver.

The current invention uses as an example adjusting device drivers on Linux operating systems.

The alternative ways of use of the invention is under:
other operating systems which include customizing information on device drivers
or, Linux and other operating systems which include customizing information on system software other than device drivers
or, Linux and other operating systems which include customizing information on application software

The software programs based on the said method can have embodiments where:
the outside device driver is adjusted locally on the target operating system
or, the kernel related files of the target operating system are sent to another computer system, on which is done the adjusting of the outside device driver, and which is sent back to the target os

The invention allows:
the developer to keep the source code proprietary, outside of the Linux kernel
and, reduces the burden to the developer, and makes it quick and easy to verify the work and provide driver updates
and, the allows the customer to have the freedom to do updates of the hardware or the system software—kernel/distro, at any time they wish

### BRIEF DESCRIPTION OF THE DRAWINGS

FIG. 1. is a diagram showing the content of a binary of a driver file, including customizing information

FIG. 2. is a diagram showing the sequence of steps for adjusting of a binary of a driver file

### DETAILED DESCRIPTION OF THE INVENTION

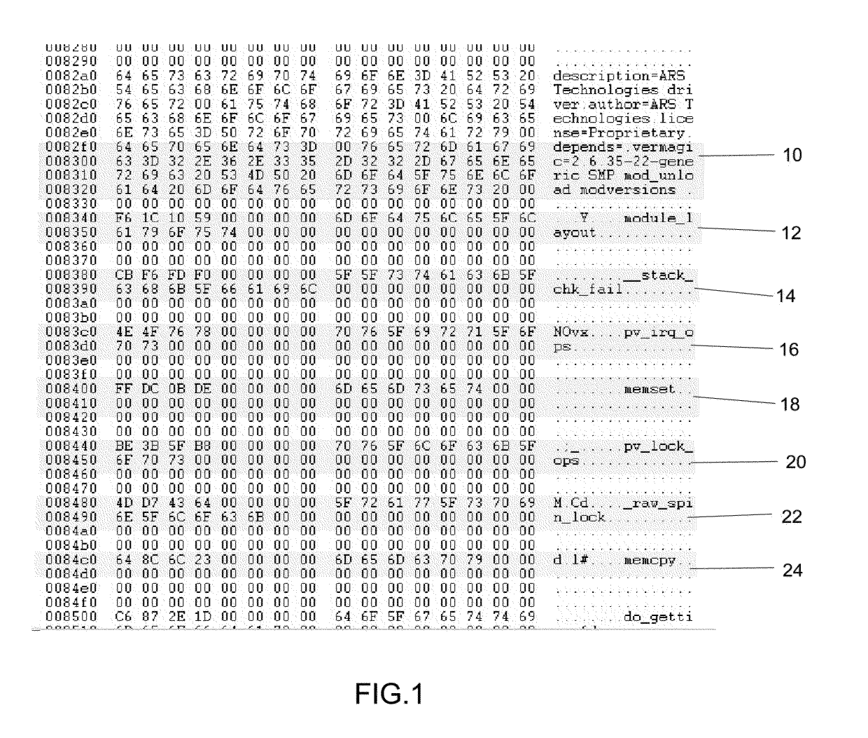

FIG. 1. shows the content of a binary of a Linux driver file, including customizing information.

The results are obtained by a binary file editor program, shown as follows:
on the left side there is a column presenting the addresses, where each line is 16 bytes (10 hex). The addresses visible in the diagram range from 008290 to 008500 hexadecimal
in the middle of the diagram are shown data values, byte by byte, in hexadecimal values
on the right side there is a column representing the data as ASCII text

There are highlighted areas which show customizing information, where:
10 is a string—‘vermagic=2.6.35-22 generic SMP mod_unload modversions’; the string includes the kernel number 2.6.35, sub-release number 22;
12 is a symbol with a name—‘module_layout’, and checksum data—‘F6,1C,10,59’
14 is a symbol with a name—‘_stack_chk_fail’, and checksum data—‘CB,F6,FD,F0’
16 is a symbol with a name—‘pv_irq_opps’, and checksum data—‘4E,4F,76,78’
18 is a symbol with a name—‘memset’, and checksum data
‘FF,DC,OB,DE’
20 is a symbol with a name—‘pv_lock_ops’, and checksum data—‘BE,3B,5F,B8’
22 is a symbol with a name—‘_raw_spin_lock’, and checksum data13 ‘4D,D7,43,64’
24 is a symbol with a name—‘memcpy’, and checksum data
‘64,8C,6C,23’

The ‘vermagic’ string is the same for a particular Linux distribution release, and will be the same between different computer systems having this particular distribution release installed. However another distribution release will have a different string.

The ‘symbols’ as shown in by 12, 14, 16, 18, 20, 22, 24 have the names of kernel functions, and some checksum data.

The said will have different values if the particular Linux distribution release is installed on a different computer system.

The checksum data will have different values if another Linux distribution release is installed on the current/same computer system as well.

In this way the Linux driver, a portion of which is shown in the diagram can not load on a different computer system having the same distribution, or the same system having another distribution.

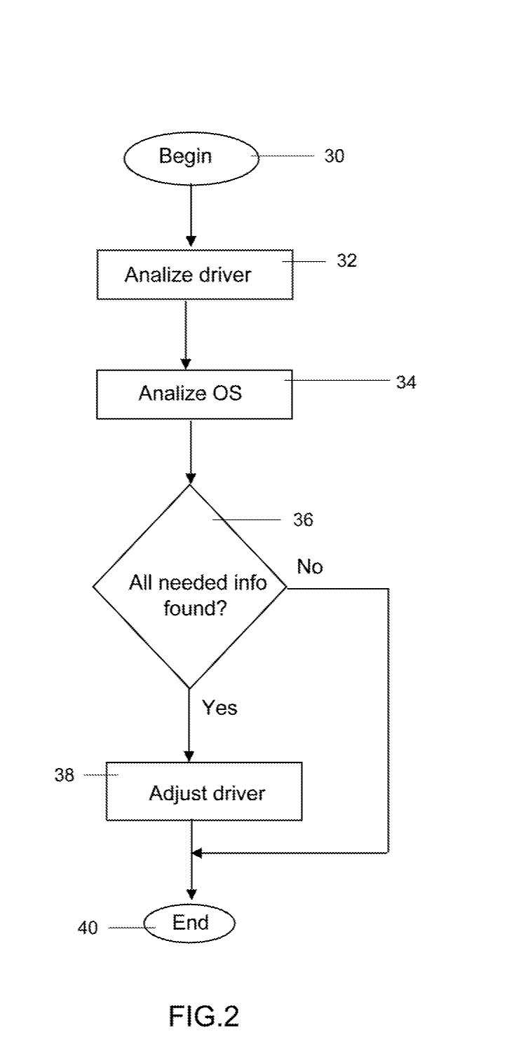

FIG. 2. shows the sequence of steps for adjusting of a binary of a driver file built on one initial operating system, to load and work on one target operating system.

The sequence of steps starting with 30—begin, can be performed under the same target operating system, or on another operating system environment. If performed on another os, the initial driver and information from the target operating system has to be transferred to the other operating system environment.

In the step 32 the method and the program based on the method reads the content of the binary of a driver file as shown on FIG. 1. and collects information on the ‘vermagic’ string, and the names of all functions used by the driver, like for ex.—‘module_layout’, ‘_stack_chk_fail’, ‘pv_irq_opps’, ‘memset’ and all of the following symbols.

In the step 34 the target operating system is analyzed—binaries of files read, to find the ‘vermagic’ string, and all the symbols found in step 32. Once a symbol is found, then the checksum data value for it is obtained.

Step 36 analyzes if all the needed information, including symbols and their checksums are obtained from the target operating system. If not all the needed information is found, the method and the program based on the method do to step 40—end.

If all the needed information is found, step 38 does adjusting of the binary of a driver file built on one initial operating system. In this step the ‘vermagic’ string, the checksum data and all other customizing information is replaced. In this way the adjusted driver can load and work on the target operating system.

If the sequence of steps are performed on another os, different than the target operating system, at the point of step 40—end, the adjusted driver may be transferred to the target operating system.

The invention can have number of embodiments, including:
one or more computer programs running on the current target operating system
one or more computer programs running on another operating system, and adjusting a driver for the target operating system
two or more computer programs running on 2 operating systems—target and another operating system, connected and communicating with each other to produce adjusting of a driver
one or more computer programs running on Linux operating system or another operating system which produce adjusting of a driver for loading and work on non Linux operating system which use customizing information

The implementing of the described method of the invention in the way of a software will be well known for those with ordinary skills in hardware and software design.

The description of the embodiments of this invention has been presented for purposes of illustration. The embodiments were chosen and described to provide the best illustration of the principles of this invention and its practical application.

Those skilled in the art are enabled by the said illustration to utilize the invention in various embodiments and with various modifications as are suited to the particular use contemplated.

All such modifications and variations are within the scope of the present invention as determined by the appended claims.

1. A method for adjusting of a binary file built under one initial operating system environment in a way to load on multiple other target operating system (os) environments which include customizing information, where both the said file and the files of the target os-es are analyzed and data within the said file is replaced with data obtained from the binaries of the target os-es.

2. One or more software programs implemented based on the method from claim 1.

3. The software programs from claim 2 where no source code of the file built under the initial operating system environment is used for producing of a binary file which loads on the target os.

4. The software programs from claim 2 where no kernel source code or header files of the target os are used for producing of a binary file which loads on the target os.

5. The software programs from claim 2 where the customizing information of the operating system is extracted from the binary files included with it.

6. The software programs from claim 5 where Linux kernel ‘symbols’ are extracted from the binary *.ko driver files included with the operating system.

7. The software programs from claim 5 where Linux kernel ‘symbols’ are extracted from the binary file of the kernel image included with the operating system.

8. The software programs from claim 2 where the adjusting of the binary file built under one initial operating system environment is done on the target operating system.

9. The software programs from claim 2 where information from the target operating system is sent to another computer, which does analyzing of the received information and adjusting of the binary file built under one initial operating system environment, and then the adjusted file is sent to the target operating system.

10. The software programs from claim 2 where one program does only a check if the binary file built under one initial operating system can be adjusted based on information from the target operating system, and another program does adjusting of the said binary file.
